(19) United States
(12) Patent Application Publication
(10) Pub. No.: US 2018/0169847 A1
(43) Pub. Date: Jun. 21, 2018

(54) Hand-Held Power Tool Comprising a Safety Coupling

(71) Applicant: Hilti Aktiengesellschaft, Schaan (LI)

(72) Inventors: Philipp Lorenz, Muenchen (DE); Erwin Manschitz, Germering (DE); Azize Cengil, Berlin (DE)

(73) Assignee: Hilti Aktiengesellschaft, Schaan (LI)

(21) Appl. No.: 15/736,686

(22) PCT Filed: Jun. 28, 2016
(86) PCT No.: PCT/EP2016/064921

§ 371 Date: Dec. 14, 2017

(30) Foreign Application Priority Data
Jun. 30, 2015 (EP) 15174434.9

(51) Int. Cl. B25D 16/00; B25F 5/00

(52) U.S. Cl. CPC B25D 16/003; B25F 5/001; B25D 2250/145; B25D 2250/051; B25D 2250/221; B25D 2250/225; B25D 2250/095; B25D 2250/165

(57) ABSTRACT

A hand-held power tool, in particular a hammer drill or a combined hammer, includes a safety coupling via which torque transmission between a motor shaft and a transmission shaft of the hand-held power tool can be established and interrupted. The safety coupling includes a coupling part at the input end and a coupling part at the output end and can be actuated by a coupling actuator. Mutually complementary catch profiles, in particular similar to a crown gear set, by which the coupling part at the input end and the coupling part at the output end can be interlocked, are arranged on the coupling part at the input end and on the coupling part at the output end.

This application claims the priority of International Application No. PCT/EP2016/064921, filed Jun. 28, 2016, and European Patent Document No. 15174434.9, filed Jun. 30, 2015, the disclosures of which are expressly incorporated by reference herein.

### BACKGROUND AND SUMMARY OF THE INVENTION

The invention concerns a hand-held power tool, in particular a hammer drill or combined hammer, comprising a safety coupling via which torque transmission between a motor shaft and a transmission shaft of the hand-held power tool can be established and interrupted. The safety coupling includes a coupling part at the input end and a coupling part at the output end. The safety coupling can be actuated by a coupling actuator.

Such hand-held power tools are in principle known from the prior art. The safety coupling included in the hand-held power tool above all serves to protect a user of the hand-held power tool in that if a tool inserted in the hand-held power tool jams, the coupling opens and torque transmission between the motor shaft and the transmission shaft is interrupted. This can reduce deflection of the hand-held power tool resulting from the jamming of the tool.

The aim of the present invention is to create a hand-held power tool in which the safety coupling prevents unwanted deflection in case of jamming of the tool as much as possible and is also particularly light and compact.

The aim is achieved in that the coupling part at the input end and the coupling part at the output end are assigned complementary catch profiles, in particular in the form of crown wheel gearing, via which the coupling part at the input end and the coupling part at the output end can be coupled in a frictionally locked/form-fitting manner.

The invention comprises the knowledge that hand-held power tools known from the prior art that may, for example, have a frictionally locked safety coupling may indeed realize a short opening time and self-opening of the safety coupling, but with the disadvantage of a comparably high weight and comparably large installation space of the safety coupling. This must be considered disadvantageous for a hand-held power tool.

The complementary catch profiles provided for by the invention create a safety coupling that has both a short opening time and a self-opening function and can transmit significantly higher torques with the same installation space in comparison to a frictionally locked coupling. In this way a light and compact safety coupling is provided. In addition, the invented safety coupling can be constructed in a particularly simple way and electric motor braking in the hand-held power tool can be omitted.

The invention further comprises the knowledge that because of their price and easy controllability, hand-held power tools are often provided with electric motors with carbon brushes. In hand-held power tools known from the prior art, costly engine braking mechanisms are typically provided to avoid wear to the brushes caused by abrupt deflection of the hand-held power tool.

As already mentioned at the start, the complementary catch profiles arranged on the coupling part at the input side and on the coupling part at the output side can be designed in the form of crown wheel gearing. Any front sides of the coupling parts are preferably free of catch profiles. The complementary catch profiles are preferably formed in a ring shape. It is particularly preferable for the catch profiles to each have wedge elements that protrude from the catch profile axially to the coupling direction. In the case of the present invention, axial is understood to mean a direction oriented parallel to the coupling direction.

According to an advantageous embodiment, the height of a wedge element can be between 0.3 mm to 1 mm. A height for a wedge element of 0.5 mm is considered particularly advantageous. The height of a wedge element here means the maximum extension of a wedge element from the coupling part at the input side to the coupling part at the output side.

In a particularly preferable embodiment, the wedge elements are configured asymmetrically. Through wedge elements configured in this way, the stroke or pathway connecting the coupling part at the input side to the coupling part at the output side can be significantly reduced. This reduction of the stroke or pathway can also significantly reduce the coupling actuator and/or the force from the coupling actuator needed to close the coupling in comparison to the prior art. As a result a particularly small installation height of the safety coupling can be made possible.

Because the complementary catch profiles can be configured in the form of crown wheel gearing and/or because the wedge elements can protrude axially to the coupling direction, the safety coupling is self-opening when the torque is in contact and the coupling actuator is not activated. This is because an axially acting coupling opening force is acting on the safety coupling. Because of the short opening time of the safety coupling created in this way, a small deflection angle of the hand-held power tool is achieved if the tool jams, significantly increasing the user's safety.

It has proven to be advantageous if the coupling part at the input side is attached to a flange of the safety coupling at the input side via a spring element that is elastically deflectable axially in the coupling direction. Alternately, the catch profile configured on the coupling part at the input side can be fixed to the coupling part at the input side via a spring element that is elastically deflectable axially in the coupling direction. The flange at the input side is preferably attached to the motor shaft in a non-rotating manner.

The coupling part at the output side can be fixed to a flange of the safety coupling at the output side via a spring element that is elastically deflectable axially in the coupling direction. Alternatively, the catch profile configured on the coupling part at the output side can be fixed to the coupling part at the output side via a spring element that is elastically deflectable axially in the coupling direction. The flange at the output side is preferably attached to the transmission shaft in a non-rotating manner.

The spring element can preferably be installed pre-stressed in such a way that the complementary catch profiles are separated from each other when the coupling actuator is not activated, i.e., the safety coupling is uncoupled.

Alternatively, the catch profile configured on the coupling part at the output side can be fixed to the coupling part at the output side via a spring element that is elastically deflectable axially in the coupling direction. Here, too, the spring element is preferably installed pre-stressed in such a way that the complementary catch profiles are separated when the coupling actuator is not activated.

It has proven to be advantageous if the coupling part at the input side is positioned to be axially displaceable in the coupling direction or the coupling part at the output side is positioned to be axially displaceable in the coupling direction.

In a particularly preferable embodiment, the motor shaft and the transmission shaft are arranged coaxially to one another. At the same time, the coupling part at the output side and the coupling part at the input side can be arranged coaxially to one another and preferably in turn arranged coaxially to the motor shaft and transmission shaft. It is particularly preferable to arrange the ring-shaped catch profiles coaxially to the motor shaft and to the transmission shaft. In this way the safety coupling can be provided in particularly compact form.

It has proven to be advantageous if the coupling actuator is an electromagnetic actuator with an actuator coil.

Through the invention's configuration of the coupling part at the input side and at the output side with a complementary catch profile, the stroke or pathway needed for the coupling actuator configured as an electromagnetic actuator to connect the coupling part at the input side to the coupling part at the output side can be significantly and advantageously reduced, as the length of the stroke or pathway for closing the coupling constitutes a disadvantageous resistance to the magnetic flux of the coupling actuator, configured as an electromagnetic actuator. Through this reduction of the stroke or pathway, the coupling actuator configured as an electromagnetic actuator and the magnetic force of the coupling actuator configured as an electromagnetic actuator needed to close the coupling can also be significantly reduced compared to the prior art.

The electromagnetic actuator is preferably configured and arranged to trigger the coupling part at the input side acting as an anchor or the coupling part at the output side acting as an anchor, preferably to trigger it in a contactless manner. This offers the advantage that a force transmission element between the actuator coil and catch profile can be omitted, in particular a rigid force transmission element arranged serially in the flux, such as a lever arm or similar.

Alternatively or additionally, the electromagnetic actuator can be configured and arranged to trigger the catch profile acting as an anchor in a contactless manner.

The catch profile, the coupling part at the input side and/or the coupling part at the output side can be magnetically soft. Alternatively, the catch profile, the coupling part at the input side, and/or the coupling part at the output side can be magnetically hard.

In another preferred embodiment, the safety coupling is open when the actuator coil has no current. Then the elastically deflectable spring element, which is installed pre-stressed, is enough to keep the complementary catch profiles separated when the actuator coil has no current. In the opposite case, when the actuator coil is running a current, the magnetic force acting through the actuator coil on the catch acting as an anchor is large enough to compensate for the spring force of the spring element and keep the complementary catch profiles interlocked for torque transmission. Alternatively, the safety coupling can be closed when the actuator coil has no current.

The actuator coil can be attached in a fixed manner to a housing of the hand-held power tool. Alternatively, the actuator coil can be attached in a non-rotating manner to the motor shaft. A non-rotating connection can be, for example, frictionally locked or form-fitting. An actuator coil attached in a non-rotating manner to the motor shaft is preferably provided via a sliding contact with an actuation current. The sliding contact can preferably be realized via at least one slip ring and at least one brush, preferably arranged in pairs.

The hand-held power tool can have an electronic unit for detecting an abrupt deflection of the hand-held power tool, wherein the electronic unit is configured and arranged to set the actuator coil to no current if an abrupt deflection of the hand-held power tool is detected. Alternatively, the hand-held power tool can have an electronic unit for detecting an abrupt deflection of the hand-held power tool, wherein the electronic unit is configured and arranged to run current through the actuator coil if an abrupt deflection of the hand-held power tool is detected.

Alternatively or in addition to the electronic unit for detecting an abrupt deflection of the hand-held power tool, an electronic unit can be provided for detecting an angular acceleration of at least one component of and/or the whole hand-held power tool to in this way identify an abrupt deflection of the hand-held power tool. Here the electronic unit for detecting an angular acceleration is configured and arranged to set the actuator coil to no current if an angular acceleration of at least one component of and/or the whole hand-held power tool is detected. Alternatively, the hand-held power tool can have an electronic unit for detecting an angular acceleration of at least one component of and/or the whole hand-held power tool to in this way identify an abrupt deflection of the hand-held power tool. Here the electronic unit is configured and arranged to run current through the actuator coil if an angular acceleration of at least one component and/or the whole hand-held power tool is detected.

According to another embodiment, the hand-held power tool can have an electronic unit for detecting a change of at least one predetermined physical parameter of the hand-held power tool, wherein the change in the at least one predetermined physical parameter acts as reason for or indication of an abrupt deflection of the hand-held power tool and therefore for the opening of the safety coupling. The electronic unit for detecting a change in at least one predetermined physical parameter is configured and arranged to set the actuator coil to no current if a change in at least one predetermined physical parameter is detected. Alternatively, the hand-held power tool can have an electronic unit for detecting a change in at least one predetermined physical parameter of the hand-held power tool, wherein the electronic unit is configured and arranged to run current through the actuator coil if a change in at least one predetermined physical parameter of the hand-held power tool is detected.

Other advantages are shown in the following description of the figures. The figures depict various exemplary embodiments of the present invention. The figures, the description, and the claims contain numerous features in combination. The person skilled in the art will also consider the features individually as appropriate and bring them together in meaningful additional combinations.

In the figures, identical and equivalent components are numbered with identical reference symbols.

### BRIEF DESCRIPTION OF THE DRAWINGS

FIG. 1 illustrates a first exemplary embodiment of a hand-held power tool according to the invention;

FIG. 2 illustrates a catch profile of the safety coupling of the hand-held power tool in FIG. 1;

FIG. 3a is a schematic depiction of a right-angled catch profile in a safety coupling according to the prior art;

FIG. 3b is a schematic depiction of a catch profile with wedge elements of a safety coupling of a hand-held power tool according to the invention;

FIG. 3c is a graphical comparison of the pre-stressing forces of a spring element in a safety coupling according to the prior art and a spring element in a safety coupling in a hand-held power tool according to the invention;

FIG. 4 illustrates another exemplary embodiment of a safety coupling in a hand-held power tool according to the invention; and

FIG. 5 illustrates another exemplary embodiment of a safety coupling in a hand-held power tool according to the invention.

### DETAILED DESCRIPTION OF THE DRAWINGS

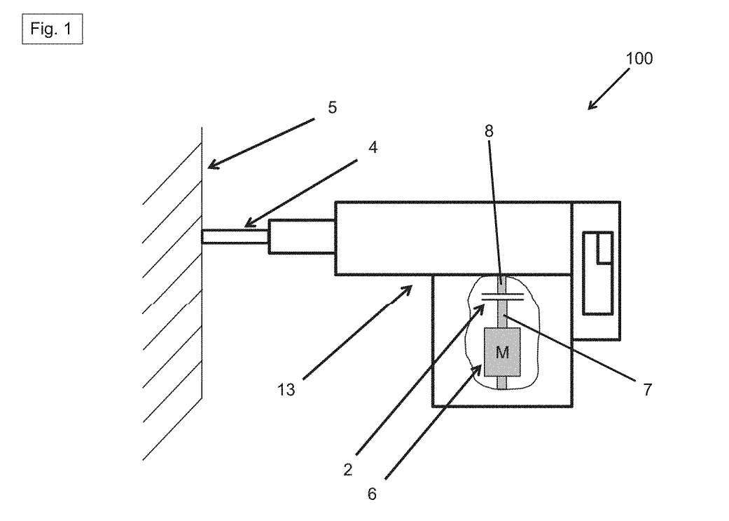

A hand-held power tool 100, here a hammer drill, is shown in FIG. 1. The hand-held power tool 100 has a housing 13 in which an electric drive motor 6 and a safety coupling 2 are arranged. The electric drive motor 6 is connected to the safety coupling 2 by the motor shaft 7. The safety coupling 2 is connected to a tool 4 inserted in the hand-held power tool 100, here a drill, by the transmission shaft 8 and a gear unit (not depicted). The tool 4 is stuck in a wall 5 to be processed.

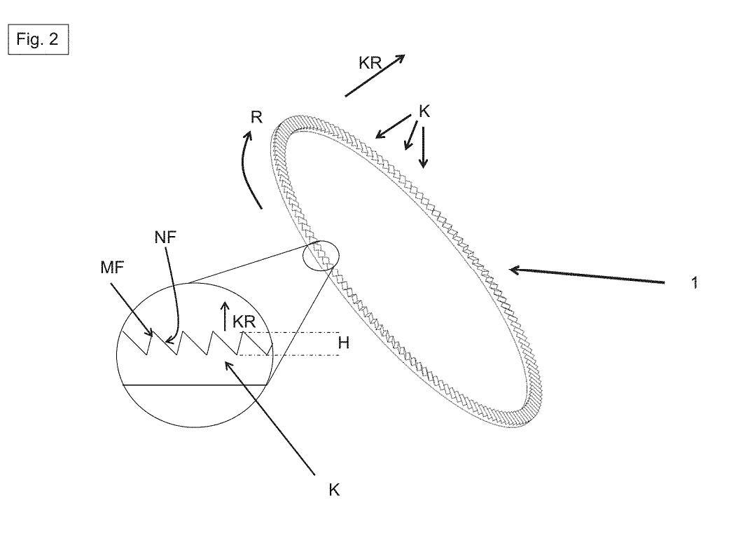

The safety coupling 2 can create and interrupt torque transmission between the motor shaft 7 and the transmission shaft 8 of the hand-held power tool 100. In the invention, the safety coupling 2 has complementary catch profiles, one of which is now described with reference to FIG. 2.

As can be seen in FIG. 2, the catch profile 1 is ring-shaped and has wedge elements K protruding axially, i.e., parallel to the coupling direction KR. In the exemplary embodiment shown here, numerous wedge elements K are arranged equally spaced along the ring-shaped catch profile. As can also be seen in FIG. 2, the catch profile 1 is configured as crown wheel gearing, i.e., the radial side surfaces of the catch profile are free of any teeth and free of wedge elements. The rotation direction R of the catch profile 1 during proper operation of the hand-held power tool is shown accordingly.

The wedge element K has a height H of approx. 0.5 mm. However, it is also possible for the height H of the wedge element K to fall in a range from 0.3 to 1 mm. In addition, however, it is also possible for the height H to have a value greater than 1 mm or a value less than 0.3 mm.

An asymmetric configuration of the wedge elements K is easy to discern in the enlargement shown at the bottom left in FIG. 2. A steep catch flank MF that is running forward in the rotation direction R is steeper than a flank NF that is running backward in the rotation direction R.

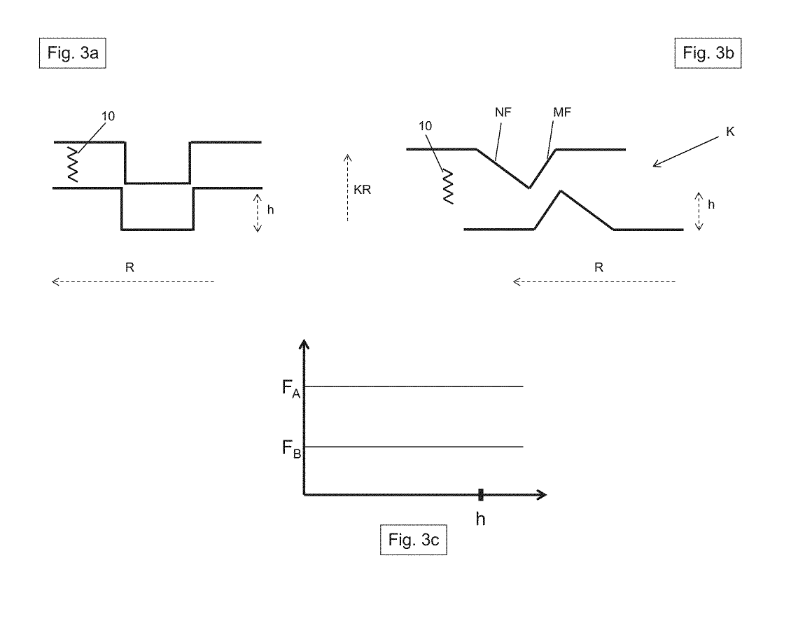

FIG. 3a shows a schematic depiction of a right-angled catch profile in a safety coupling according to the prior art. FIG. 3b shows a schematic depiction of a catch profile with wedge elements K in a safety coupling of a hand-held power tool according to the invention. The spring element 10 acts to separate and open the safety coupling in each case.

In the case of the right-angled catch profile in the safety coupling according to the prior art, the spring element 10 must actively pull apart the two loaded coupling parts, i.e., the coupling part at the input side and the coupling part at the output side. Because of the relatively large frictional force caused by the normal force being in contact, a spring element 10 with a relatively high spring force FA must be used to be able to separate and open the safety coupling. It is necessary here for this spring force FA to already be in contact at a stroke distance of h=0, i.e., when the coupling is open and just before the two coupling parts touch. Thus a relatively high pre-stressing of the spring element 10 is needed in the safety coupling according to the prior art. If the safety coupling according to the prior art uses a magnet to connect and close the two coupling parts, this magnet must be chosen so that it can generate the relatively high spring force FA when the coupling is open. Consequently a relatively large or strong magnet must be chosen to be able to close the coupling against the spring force FA of the relatively large spring element.

In contrast to this, using the catch profile 1 in the form of crown wheel gearing with wedge elements K allows a significantly smaller and weaker spring element with a significantly smaller spring force F_{B} to be chosen for a safety coupling in a hand-held power tool according to the invention. Theoretically, the spring force F_{B} of the spring element 10 can be chosen independently of the opening of the coupling, since when loaded an opening axial force is already generated for opening and separating the two coupling parts, i.e., the coupling part at the input side from the coupling part at the output side, because of the wedge elements K. The spring element 10 therefore acts only to keep the two coupling parts from engaging. As a result of this, a relatively small and weak spring element can be chosen with a spring force F_{B} smaller than the spring force FA (see FIG. 3c).

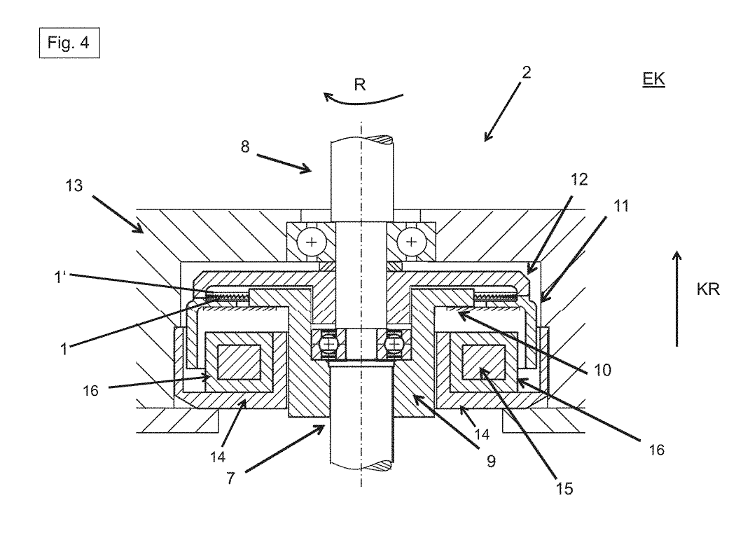

A cross-sectional view of a safety coupling 2 in a hand-held power tool according to the invention is shown in FIG. 4. FIG. 4 shows the coupled state EK of the safety coupling 2. In the coupled state EK, torque can be transmitted between a motor shaft 7 and a transmission shaft 8.

The safety coupling 2 has a coupling part at the input side 11 and a coupling part at the output side 12. A ring-shaped catch profile 1 (see FIG. 2) is arranged on the coupling part at the input side 11. A complementary ring-shaped catch profile 1′ (see FIG. 2) is arranged on the coupling part at the output side 12. The coupling part at the output side 12 is connected in a non-rotating manner, e.g., in a frictionally locked or form-fitting manner, to the transmission shaft 8. The coupling part at the input side 11, which bears the ring-shaped catch profile 1, is arranged to be axially displaceable in the coupling direction KR. This arrangement is achieved by an elastically deflectable spring element 10 via which the coupling part at the input side 11 with the catch profile 1 arranged on it is connected to a flange at the input side 9. The flange at the input side 9 is in turn connected in a non-rotating manner to the motor shaft 7.

As can be seen in FIG. 4, the flange at the input side 9 has a ball bearing between motor shaft 7 and transmission shaft 8 in which the transmission shaft 8 is arranged. This facilitates the alignment of motor shaft 7 and transmission shaft 8.

As already mentioned, FIG. 4 shows the coupled state EK. A torque raised by the electric drive motor (not depicted here) passes from the motor shaft 7 to the flange at the input side 9 connected in a non-rotating manner to the motor shaft 7 and from there to the coupling part at the input side 11 through the spring element 10 that is elastically deflectable axially in the coupling direction KR.

The coupling part at the input side 11, which is in the present case arranged to be axially displaceable to the coupling direction KR, transmits the torque to the coupling part at the output side 12, which in turn has a complementary catch profile 1′. Through the coupling part at the output side 12, which is attached in a fixed position to the transmission shaft 8, the torque passes to a gear unit not depicted here. The transmission shaft 8 is arranged to be rotatable in a housing 13 of the hand-held power tool.

As can also be seen in FIG. 4, the motor shaft 7, the transmission shaft 8, and the ring-shaped complementary catch profiles 1, 1′ are placed coaxially to one another.

A coupling process is described in more detail below with reference to the coupling actuator. In this case, the coupling actuator is an electromagnetic actuator with an actuator coil 15 that is arranged in a fixed position in respect to the housing 13 via a coil holder 14. To protect the actuator coil 15, it is enveloped in a layer of insulation 16.

Admitting an actuation current to the actuator coil 15 pulls the coupling part at the input side 11 to the coupling part at the output side 12, engaging the complementary catch profiles 1, 1′ as shown in FIG. 4.

The hand-held power tool can have an electronic unit for detecting an abrupt deflection of the hand-held power tool, wherein the electronic unit is configured and arranged to set the actuator coil 15 to no current if an abrupt deflection of the hand-held power tool is detected. Here the electronic unit can be configured and arranged to detect an angular acceleration and/or a predetermined change in at least one physical parameter of at least one component of and/or the whole hand-held power tool to in this way detect an abrupt deflection of the hand-held power tool.

Because of the pre-stressed installed spring element 10 and the axial force generated by the wedge elements K, setting the actuator coil 15 to no current moves the coupling part at the input side 11 away from the coupling part at the output side 12 and separates the complementary catch profiles 1, 1′ so that torque transmission between the motor shaft 7 and the transmission shaft 8 is interrupted.

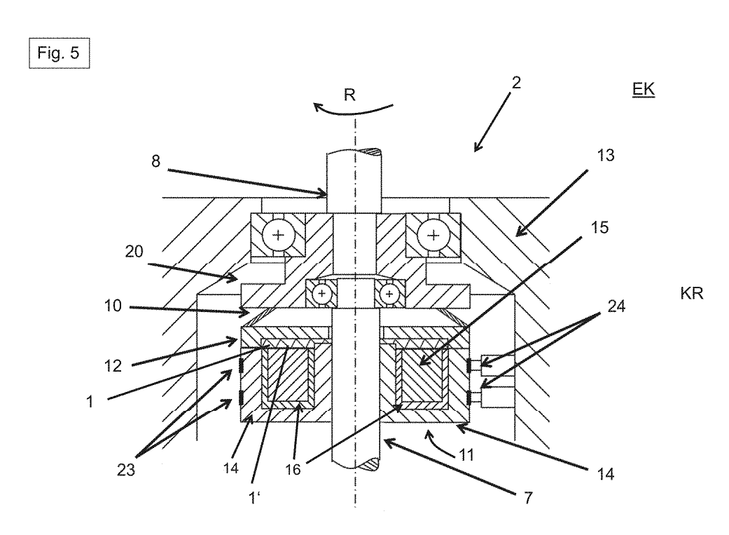

Another exemplary embodiment of a safety coupling 2 of a hand-held power tool is shown in FIG. 5. The safety coupling 2 shown in FIG. 5 is also intended to transmit torque between a motor shaft 7 and a transmission shaft 8. In contrast to the exemplary embodiment in FIG. 4, in which the actuator coil 15 is attached in a fixed manner to the housing 13 of the hand-held power tool, in the exemplary embodiment in FIG. 5 the actuator coil 15 is arranged in a coil holder 14, wherein the coil holder 14 is attached in a non-rotating manner to the motor shaft 7. Accordingly, the actuator coil 15 rotates together with the motor shaft 7 in the rotation direction R. To allow current to run through the coil, the coil holder 14 has slip rings 23 arranged in pairs in the circumferential direction that are electrically connected to the actuator coil 15. The slip rings 23 arranged in pairs are in sliding contact with a fixed pair of brushes 24 so that current can be run through the actuator coil 15 as needed.

In the exemplary embodiment shown in FIG. 5, the coupling part at the input side 11 is formed by the coil holder 14 and actuator coil 15 and attached in a non-rotating manner or a fixed position to the motor shaft 7. The catch profile 1, configured to be ring-shaped in the present case, is connected in a non-rotating manner to the coupling part at the input side 11. In the exemplary embodiment shown here, the catch profile 1 is connected applied to both the coupling part at the output side 12 and to the coil holder 14.

Furthermore, the coupling part at the output side 12, which carries the complementary catch profile 1′, is axially displaceable in the coupling direction KR. As can also be seen in FIG. 5, the spring element 10 that is elastically deflectable axially in the coupling direction KR is fixed to a flange at the output side 20 of the safety coupling 2. Through this spring element 10, the coupling part at the output side 12 with the complementary catch profile 1′ is fixed in a non-rotating manner to the flange at the output side 20. The flange at the output side 20 is in turn attached in a non-rotating manner to the transmission shaft 8. The flange at the output side 20 and the transmission shaft 8 are arranged to be rotatable in the housing 13.

As soon as current runs through the actuator coil 15 via the slip rings 23 and the brush 24 that is in contact with the slip rings, an electromagnetic field is generated that shifts the coupling part at the output side 12, which acts as an anchor, downwards out of the position shown in FIG. 5 axially to the coupling direction KR. Thus the safety coupling 2 is closed, i.e., the complementary catch profiles 1, 1′ engage and interlock. The safety coupling 2 shown in FIG. 5 is configured so that the safety coupling 2 is open when the actuator coil 15 is set to no current.

### LIST OF REFERENCE SYMBOLS

1, 1′ Catch profile
2 Safety coupling
4 Tool
5 Wall
6 Electric drive motor
7 Motor shaft
8 Transmission shaft
9 Flange of the safety coupling at the input side
10 Spring element
11 Coupling part at the input side
12 Coupling part at the output side
13 Housing
14 Coil holder
15 Actuator coil
20 Flange of the safety coupling at the output side
15 Actuator coil
23 Slip ring
24 Brush
100 Hand-held power tool
EK Coupled stated
KR Coupling direction
MF Catch flank
NF Flank running backwards
R Rotation direction
K Wedge elements

1.-13. (canceled)

14. A hand-held power tool, comprising:
a safety coupling, wherein a torque transmission between a motor shaft and a transmission shaft of the hand-held power tool is establishable and interruptible by the safety coupling and wherein the safety coupling includes a first coupling part at an input side and a second coupling part at an output side;
a coupling actuator, wherein the safety coupling is actuatable by the coupling actuator; and
complementary catch profiles, wherein the complementary catch profiles are respectively disposed on the first coupling part and the second coupling part and wherein the first coupling part and the second coupling part are coupleable in a frictionally locked/form-fitting manner by the complementary catch profiles.

15. The hand-held power tool according to claim 14, wherein each of the complementary catch profiles is a crown wheel gearing.

16. The hand-held power tool according to claim 14, wherein each of the complementary catch profiles is ring-shaped and has wedge elements protruding axially to a coupling direction.

17. The hand-held power tool according to claim 16, wherein the wedge elements are configured asymmetrically.

18. The hand-held power tool according to claim 14, wherein the first coupling part is fixed to a flange of the safety coupling at the input side by a spring element, wherein the spring element is elastically deflectable axially in a coupling direction, and wherein the flange is connected non-rotatably to the motor shaft.

19. The hand-held power tool according to claim 14, wherein the second coupling part is fixed to a flange of the safety coupling at the output side by a spring element, wherein the spring element is elastically deflectable axially in a coupling direction, and wherein the flange is connected non-rotatably to the transmission shaft.

20. The hand-held power tool according to claim 18, wherein the spring element is installed pre-stressed such that the complementary catch profiles are separated from each other when the coupling actuator is not activated.

21. The hand-held power tool according to claim 19, wherein the spring element is installed pre-stressed such that the complementary catch profiles are separated from each other when the coupling actuator is not activated.

22. The hand-held power tool according to claim 14, wherein the first coupling part is axially displaceable in a coupling direction or the second coupling part is axially displaceable in the coupling direction.

23. The hand-held power tool according to claim 14, wherein the motor shaft and the transmission shaft are disposed coaxially to each other.

24. The hand-held power tool according to claim 14, wherein the coupling actuator is an electromagnetic actuator with an actuator coil that triggers the first coupling part or the second coupling part in a contactless manner.

25. The hand-held power tool according to claim 14, wherein the coupling actuator is an electromagnetic actuator with an actuator coil and wherein the safety coupling is open when the actuator coil is set to no current.

26. The hand-held power tool according to claim 14, wherein the coupling actuator is an electromagnetic actuator with an actuator coil and wherein the actuator coil is fixedly attached to a housing of the hand-held power tool.

27. The hand-held power tool according to claim 14, wherein the coupling actuator is an electromagnetic actuator with an actuator coil, wherein the actuator coil is non-rotatably attached to the motor shaft, and wherein the actuator coil is supplyable with an actuation current via a sliding contact that is a slip ring and a brush.

28. The hand-held power tool according to claim 14 further comprising an electronic unit, wherein an abrupt deflection of the hand-held power tool is detectable by the electronic unit and wherein the electronic unit sets the coupling actuator to no current in an occurrence of the abrupt deflection.
